(19) United States
(12) Patent Application Publication
(10) Pub. No.: US 2025/0229669 A1
(43) Pub. Date: Jul. 17, 2025

(54) METHOD AND APPARATUS FOR CONTROLLING BATTERY OF ECO-FRIENDLY VEHICLE

(71) Applicants: Hyundai Motor Company, Seoul (KR); Kia Corporation, Seoul (KR)

(72) Inventor: Hyun Soo PARK, Seoul (KR)

(73) Assignees: Hyundai Motor Company, Seoul (KR); Kia Corporation, Seoul (KR)

(21) Appl. No.: 18/796,496

(22) Filed: Aug. 7, 2024

(30) Foreign Application Priority Data
Jan. 11, 2024 (KR) 10-2024-0004883

(51) Int. Cl. B60L 58/22; B60L 58/13; B60L 58/20; H02J 7/00

(52) U.S. Cl. CPC B60L 58/22; B60L 58/13; B60L 58/20; H02J 7/007194; B60L 2240/545; B60L 2240/547; B60L 2240/549

(57) ABSTRACT

A method and an apparatus for controlling a battery of an eco-friendly vehicle are provided. The method for controlling the battery of the eco-friendly vehicle includes a step of determining an output distribution ratio for a required output of a vehicle based on a voltage of each of a first and a second battery, a step of supplying a power to the vehicle by controlling an output of the first battery and the second battery based on the output distribution ratio, and a step of adjusting the output distribution ratio based on the satisfied emergency control entry condition when a preset emergency control mode entry condition is satisfied.

### CROSS-REFERENCE TO RELATED APPLICATION

The present application claims priority to Korean Patent Application No. 10-2024-0004883, filed on Jan. 11, 2024, the entire contents of which is incorporated herein for all purposes by this reference.

### BACKGROUND OF THE PRESENT DISCLOSURE

### Field of the Present Disclosure

The present disclosure relates to a method and an apparatus for controlling a battery of an eco-friendly vehicle, and specifically to the method and the apparatus for controlling a deterioration balance between a main battery and an auxiliary battery.

### Description of Related Art

As interest in an environment has recently increased, the number of eco-friendly vehicles provided with an electric motor as a power source is increasing. The eco-friendly vehicles are also called electric vehicles, and representative examples include hybrid vehicles (HEV: Hybrid Electric Vehicle) or electric vehicles (EV: Electric Vehicle).

In general, cost competitiveness is the most important item for a small or a light electric vehicle, and cost reduction of a power electronics (PE) component as well as a high-voltage battery is very important. Meanwhile, the most expensive component among high-voltage power electronic components is the high-voltage battery and a capacity of the high-voltage battery should be minimized, so that a price of power electronic components may be reduced. However, when the capacity of the high-voltage battery decreases, a driving distance of the electric vehicle not only decreases, but an output of a motor and inverter also decreases.

Recently, to minimize a price of the electric vehicle, a consideration has been being given to reducing a battery capacity and lowering a voltage. Currently, an electric vehicle consisting of a 48V class system has also been being developed to minimize the price of the vehicle. Furthermore, a system not only to increase the driving distance but also increase the output of the motor and the inverter has been being developed by adding a replaceable auxiliary battery to a 48V main battery.

Meanwhile, the auxiliary battery has fewer cells than the main battery, a lower rated voltage, and requires greater current consumption despite producing the same output. Therefore, when the vehicle is driven using the auxiliary battery without a separate control strategy, the auxiliary battery may relatively deteriorate more rapidly than the main battery. As a result, the batteries may not function properly or quality costs of the batteries may increase due to an early replacement of the batteries.

Therefore, in the present field of the present disclosure, a rapid deterioration of the auxiliary battery is prevented through controlling a deterioration balance between the main battery and the auxiliary battery, and a battery control technology to maximize performance of the batteries through a balanced use of the batteries has been demanded.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method and an apparatus for controlling a battery of an eco-friendly vehicle to prevent a rapid deterioration of the auxiliary battery through a deterioration balancing control between a main battery and an auxiliary battery.

Another various aspect of the present disclosure is directed to providing the method and the apparatus for controlling the battery of the eco-friendly vehicle to maximize performance of the batteries through using the batteries in a balanced way.

Technical challenges to be achieved in an exemplary embodiment of the present disclosure are not limited to the technical challenges mentioned above, and other technical challenges not mentioned will be clearly understood by those skilled in the art from the following description.

To achieve the above challenges, according to various exemplary embodiments of the present disclosure, the method for controlling the battery of the eco-friendly vehicle includes determining an output distribution ratio for a required output of a vehicle based on a voltage of each of a first battery and a second battery; supplying a power to the vehicle by controlling an output of the first battery and the second battery based on the output distribution ratio; and when a preset emergency control mode entry condition is satisfied, adjusting the output distribution ratio based on the satisfied emergency control entry condition.

For example, the output distribution ratio may be determined to be the same as a ratio of voltages of the first battery and the second battery.

For example, the method for controlling the battery of the eco-friendly vehicle may further include comparing a difference in a ratio of a cumulative current usage between the first battery and the second battery with a preset threshold ratio; and controlling the output of the first battery and the second battery based on a cumulative current correction factor when the difference in the ratio of the cumulative current usage between the first battery and the second battery is greater than the preset threshold ratio.

For example, the cumulative current correction factor is determined based on the equation below,

$$Com\_Factor = 1 - \frac{S\_Acc \_Current}{M\_Acc \_Current}$$

where Com_Factor is the cumulative current correction factor, M_Acc_Current is the cumulative current usage of the first battery, and S_Acc_Current is the cumulative current usage of the second battery.

For example, the satisfied emergency control mode entry condition includes a condition that a temperature of the first battery or the second battery is higher than a threshold temperature, a condition that a difference value between two of SOC(State Of Charge) of the first battery and the second battery exceeds a threshold SOC value, or a condition that one of the first battery and the second battery fails or an output of the one battery is limited.

For example, the first battery may be the main battery, and the second battery may be the auxiliary battery.

For example, when the first battery and the second battery satisfy the emergency control mode entry condition by determining whether the first battery and the second battery satisfy the emergency control mode entry condition, the method for controlling the battery of the eco-friendly vehicle may further include a step of controlling the output of the first battery and the second battery in the emergency control mode.

For example, in claim 6, in the emergency control mode, when the vehicle requires more than a threshold output within a threshold time, the power may be supplied to the vehicle using only the output of one of the first battery or the second battery.

For example, in the emergency control mode, when the difference of State of charge (SOC) value of the first and the second batter exceeds the threshold SOC value, an output ratio of a battery having a higher SOC between the first or the second battery may be set higher than a ratio of the voltages of the first battery and the second battery.

For example, in the emergency control mode, when one of either the first battery or the second battery breaks down, so that the battery is unusable and the output of the battery is limited, the output ratio of the other battery not breaking down may be set higher than the ratio of the voltages of the first battery and the second battery.

For example, the threshold ratio may be 5%.

Meanwhile, according to various exemplary embodiments of the present disclosure, an apparatus for controlling the battery of the eco-friendly vehicle further includes: a first battery and a second battery configured to store a power energy for driving the vehicle; a sensor unit including a voltage sensor configured to detect a voltage of each of the first battery and the second battery; and a battery management unit operatively connected to the sensor unit and configured to determine an output distribution ratio for a required output of the vehicle based on the voltage of each of the first battery and the second battery, control an output of the first battery and the second battery based on the output distribution ratio so that a power is supplied to the vehicle, and when a preset emergency control entry condition is satisfied, adjust the output distribution ratio based on the satisfied emergency control entry condition.

For example, the output distribution ratio may be determined to be the same as a voltage ratio of the first battery and the second battery.

For example, the battery management unit compares the difference in the ratio of a cumulative current usage between the first battery and the second battery with a preset threshold ratio, and may control the output of the first battery and the second battery based on a cumulative current correction factor, when the difference in the ratio of the cumulative current usage is greater than the threshold ratio.

[For example, the cumulative current correction factor is determined based on the equation below,

$$Com\_Factor = 1 - \frac{S\_Acc \_Current}{M\_Acc \_Current}$$

where Com_Factor may be the cumulative current correction factor, M_Acc_Current may be the cumulative current usage of the first battery, and S_Acc_Current may be the cumulative current usage of the second battery.

For example, the satisfied emergency control mode entry condition may be satisfied under a condition that a temperature of the first battery or the second battery is higher than a threshold temperature, a condition that a difference value between two of SOC value of the first battery and the second battery exceeds a threshold SOC value, or a condition that one of the first battery and the second battery fails or the output of the one battery is limited.

For example, the first battery may be the main battery, and the second battery may be the auxiliary battery.

For example, when the first battery and the second battery satisfy the emergency control mode entry condition by determining whether the first battery and the second battery satisfy the emergency control mode entry condition, the battery management unit may be configured for controlling the output of the first battery and the second battery in the emergency control mode.

For example, when the vehicle requires an output equal to or greater than the threshold output within the threshold time, the battery management unit may be configured for controlling the power to be supplied to the vehicle only from the output of either one of the first battery or the second battery.

For example, when the difference of state of charge (SOC) value of the first battery and SOC value of the second battery exceeds the threshold SOC value, the battery management unit may adjust the output distribution ratio so that the output ratio of the battery having a higher SOC value of either the first battery or the second battery is higher than the voltage ratio of the first battery or the second battery.

For example, when one of the first battery and the second battery fails or an output of the one battery is limited, the battery management unit may adjust the output distribution ratio so that the output ratio of the other battery of the first battery or the second battery is higher than the voltage ratio of the first battery and the second battery.

For example, the threshold ratio may be 5%.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF DRAWINGS

FIG. 1 is a block diagram schematically showing an apparatus for controlling a battery of an eco-friendly vehicle according to an exemplary embodiment of the present disclosure.

FIG. 2 is a block diagram schematically showing the apparatus for controlling the battery of the eco-friendly according to another exemplary embodiment of the present disclosure.

FIG. 3 is a flowchart schematically showing the apparatus for controlling the battery of the eco-friendly according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments included in the present disclosure are described in detail with reference to the accompanying drawings. In an exemplary embodiment of the present disclosure, identical or similar constituent elements are provided the same reference numerals regardless of the reference numerals of the drawings, and a repeated description thereof has been omitted. The suffixes “module” and “unit or part” for components used in the following description are provided or used interchangeably only for an ease of preparing a specification, and do not have distinct meanings or roles in themselves. Additionally, in the description of the present disclosure, when it has been determined that the detailed Description of Related Art would obscure a gist of the present disclosure, the detailed description thereof has been omitted. Furthermore, the accompanying drawings are merely intended to be able to readily understand the exemplary embodiments included herein, and thus a technical idea included herein is not limited by the accompanying drawings. It should be understood to include all changes, equivalents, and substitutions included in an idea and technical scope of the present disclosure.

A term containing an ordinal number, such as first, second, etc., may be used to describe various components. However. The above components are not limited by the above terms. The above terms are used only for a purpose of distinguishing one component from another.

When one component is referred to as being “connected” or “coupled” to another, it should be understood that it may be directly connected or coupled to another component. However it should be understood that other components may exist in between. In contrast, only when one component is referred to as being “directly connected” or “directly coupled” to another, it should be understood that there aren't other components in between.

Unless a singular expression is clearly expressed differently in context, Singular expressions include plural expressions.

In the present specification, a term such as “comprise”, “have” or “include” is intended to specify a presence of features, numbers, steps, operations, components, parts, or combinations thereof described in the present specification, therefore it should be understood that this does not exclude in advance a possibility of an existence or addition of one feature, other features, numbers, steps, operations, components, parts, or combinations thereof.

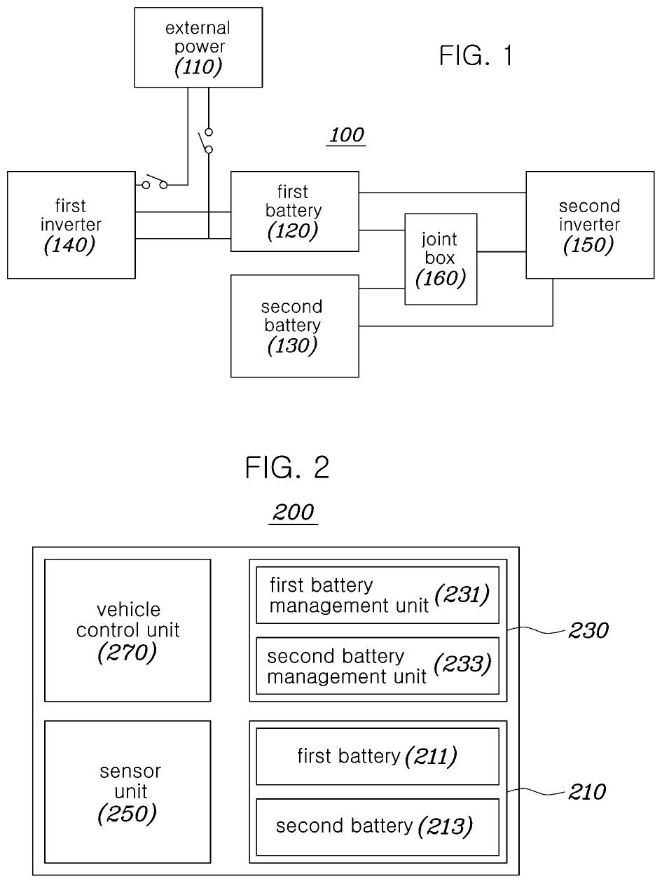

FIG. 1 is a block diagram schematically showing an apparatus for controlling a battery of an eco-friendly according to another exemplary embodiment of the present disclosure.

Referring to FIG. 1, the apparatus 100 for controlling the battery of the eco-friendly according to the exemplary embodiment includes an external power source 110, a first battery 120, a second battery 130, a first inverter 140, a second inverter 150, and a joint box 160.

The external power source 110 supplies an AC power 110 from outside of the vehicle. The first battery and the second battery 120, 130 store a power energy for driving the vehicle.

Here, the first battery 120 may be a main battery supplying a power for driving a motor, and the second battery 130 may be an auxiliary battery assisting the main battery.

The first inverter 140 converts the AC power supplied from the external power source 110 into a DC power for charging the first battery 120.

The second inverter 150 boosts the DC power supplied at a low voltage from the second battery 120 into a high voltage for supplying to the vehicle.

The joint box 160 connects the motor of the vehicle, the first battery 120, the second battery 130, or the second inverter 150 with a driving source of the vehicle or devices of the vehicle.

FIG. 2 is a block diagram schematically showing the apparatus for controlling the battery of the eco-friendly according to an exemplary embodiment of the present disclosure.

Referring to FIG. 2, the battery control device 200 for the eco-friendly vehicle according to the exemplary embodiment includes a battery 210, a battery management unit 230, a sensor unit 250, and a vehicle control unit 270.

The battery 210 stores the power energy for driving the vehicle and includes the first battery 211 and the second battery 213.

For example, the first battery 211 may be the main battery supplying the power for driving the driving source of the vehicle, and the second battery 213 may be the auxiliary battery assisting the main battery.

For example, the first battery 211 may have a voltage, namely, 800V, and the second battery 213 may have a voltage, namely, 200V.

Additionally, the first battery and the second battery 211, 213 may include a plurality of cells. The battery management unit 230 is configured to determine an output power of the first and second battery 211 and 213. Meanwhile, the battery management unit 230 including a first battery management unit 231 and a second battery management unit 233 may respectively be mounted on or connected to the first battery 211 and the second battery 213.

Additionally, the battery management unit 230 is configured to determine whether the second battery 213 is mounted on the vehicle.

For example, whether the second battery 213 is mounted the vehicle may be recognized through a Controller Area Network (CAN) communication.

For example, when the first battery management unit 231 and the second battery management unit 233 are differently mounted respectively at the first battery 211 and the second battery 213, the first battery management unit 231 and the second battery management unit 233 may identify a CAN ID (Identifier) of each other, so that whether the second battery 213 is mounted on the vehicle may be confirmed.

Additionally, whether the second battery 213 is mounted on the vehicle may be recognized through a physical wire.

For example, the first battery 211 and the second battery 213 are provided to be connected through the physical wire, and by measuring a voltage of the second battery 213 in the first battery management unit 231 mounted at the first battery 211, whether the second battery 213 may be mounted on the vehicle may be confirmed.

Meanwhile, the battery management unit 230 is configured to determine to output the power required for the vehicle using a voltage ratio of the first battery 211 and the second battery 213.

For example, the power required for the vehicle is allocated and supplied at the same ratio as each of the voltage ratio of the first battery 211 and the second battery 213.

For example, when the voltage of the first battery 211 is 800V, the voltage of the second battery 213 is 200V and the power required for the vehicle is 100 kW, the battery management unit 230 may be configured for controlling to drive the vehicle while using the vehicle control unit 270 and supplying 80 kW power from the first battery 211 and 20 kW power from the second battery 213.

For example, the voltages of the first battery 211 and the second battery 213 behave dynamically while the vehicle is running, and an output distribution ratio initially set may also be controlled to be changed in real time.

For example, when an output is accurately distributed based on the voltage ratio of the first battery and the second battery 211, 213, a current usage of the first battery and the second battery 211, 213 is the same.

Meanwhile, each output of the first battery 211 and the second battery 213 may be determined through Equation 1 and 2 below.

$$M\_Power = Power\_vehicle \times \frac{M\_Voltage}{M\_Voltage + S\_Voltage} \qquad [ Equation 1 ]$$

In the Equation 1 above, M_Power represents the output of the first battery 211, and Power_vehicle represents a required output of the vehicle. Additionally, M_Voltage represents the voltage of the first battery 211, and S_Voltage represents the voltage of the second battery 213.

$$S\_Power = Power\_vehicle \times \frac{S\_Voltage}{M\_Voltage + S\_Voltage} \qquad [ Equation 2 ]$$

In the Equation 2 above, S_Power represents the output of the second battery 213, and Power_vehicle represents the required output of the vehicle. Additionally, M_Voltage represents the voltage of the first battery 211, and S_Voltage represents the voltage of the second battery 213.

Meanwhile, because the second battery 213 converts and supplies the voltage through the inverter to supply the power to the motor, much of the power may be inefficiently used.

Accordingly, when the vehicle is running, the battery management unit 230 may operate in an emergency control mode in charge of the required output of the vehicle by considering a driving situation of the vehicle regardless of the voltage ratio of the first battery 211 and the second battery 213 and adjusting the output distribution ratio of the first battery and the second battery 211, 213.

For example, when the battery management unit 230 requires an output more than a threshold output within a short period of a threshold time, such as a time that the vehicle accelerates suddenly or climbs a hill, the battery management unit 230 may be configured for controlling the first battery 211 to take charge of all the required output of the vehicle.

Meanwhile, when a temperature of the first battery 211 is higher than a threshold temperature, the battery management unit 230 may adjust the output distribution ratio so that an output ratio of the second battery 213 may be higher than the voltage ratio between the first battery and the second battery.

Conversely, when a temperature of the second battery 213 is higher than the threshold temperature, the battery management unit 230 may adjust the output distribution ratio so that an output ratio of the first battery 211 may be higher than the voltage ratio between the first battery and the second battery.

Furthermore, when a difference value of State of Charge (SOC) between the first battery 211 and the second battery 213 exceeds a threshold SOC value, the output distribution ratio may be adjusted so that the output ratio of a battery having a higher SOC between the first battery 211 and the second battery 213 may be higher than the voltage ratio between the first battery and the second battery.

Furthermore, when one of either the first battery 211 or the second battery 213 has broken down and the battery is unusable or the output of the battery is limited, the output distribution ratio may be adjusted so that the output ratio of the other battery not having broken down may be higher than the voltage ratio between the first battery and the second battery.

Meanwhile, when the vehicle is running as above, a variation between both current usages of the first battery 211 and the second battery 213 may be increased due to adjustment of the output distribution ratio. Accordingly, the output distribution ratio of the first battery 211 and the second battery 213 may be actively controlled based on a cumulative usage of the first or the second battery 211, 213.

For example, when a difference between a ratio of a cumulative current usage to a total available current amount of the first battery 211 and a ratio of a cumulative current usage to a total available current amount of the second battery 213 is greater than a threshold ratio (Namely, when exceeding 5%), an output operation correction control mode of the first battery 211 and the second battery 213 may be entered.

For example, each output of the first battery 211 and the second battery 213 may be determined through Equation 3 and 4 below.

$$M\_Power = Power\_vehicle \times \frac{M\_Voltage}{M\_Voltage + S\_Voltage} - Com\_Factor \qquad [ Equation 3 ]$$

In the Equation 3 above, M_Power represents the output of the first battery 211, and Power_vehicle represents the required output of the vehicle. Additionally, M_Voltage represents the voltage of the first battery 211, and S_Voltage represents the voltage of the second battery 213. Additionally, Com_Factor represents a cumulative current correction factor.

$$S\_Power = Power\_vehicle \times \frac{S\_Voltage}{M\_Voltage + S\_Voltage} - Com\_Factor \qquad [ Equation 4 ]$$

In the Equation 4 above, S_Power represents the output of the second battery 213, and Power_vehicle represents the required output of the vehicle. Additionally, M_Voltage represents the voltage of the first battery 211, and S_Voltage represents the voltage of the second battery 213. Additionally, Com_Factor represents the cumulative current correction factor.

Meanwhile, Com_Factor, namely, the cumulative current correction factor in the Equations 3 and 4 above may be determined by Equation 5 below.

$$Com\_Factor = 1 - \frac{S\_Acc \_Current}{M\_Acc \_Current} \qquad [ Equation 5 ]$$

In the Equation 5, Com_Factor represents the cumulative current correction factor, M_Acc_Current represents the cumulative current usage of the first battery 211, and S_Acc_Current represents the cumulative current usage of the second battery 213.

Meanwhile, the battery management unit 230 may induce a check through a battery failure diagnosis when a battery failure diagnosis mode entry condition for the first battery 211 and the second battery 213 is satisfied.

For example, the battery failure diagnosis mode entry condition may be combined based on three conditions below.
(Condition 1) When the cumulative current correction factor (Com_Factor) is a first threshold value.
(Condition 2) When the absolute value of the difference between the cumulative usage of the first battery 211 and the cumulative usage of the second battery 213 is greater than or equal to a second threshold value.
(Condition 3) When a deviation between SOHs (State of Health) of the first battery 211 and the second battery 213 is greater than or equal to a third threshold value.

For example, the battery management unit 230 may be set to enter the battery failure diagnosis mode for checking the first battery and the second battery 211, 213 when both the condition 1 and the condition 2 are satisfied, or the condition 3 is satisfied.

For example, as a result of performing the battery failure diagnosis mode, when it is determined that a battery has broken down, the battery having broken down is stopped in operation, so that a deterioration variation may be prevented from increasing between batteries.

Additionally, the battery management unit 230 is configured to determine whether the batteries 210 satisfy an emergency control mode entry condition, and when the emergency control mode entry condition is satisfied, the battery output is controlled in an emergency control mode.

For example, the emergency control mode entry condition may be determined to be satisfied in either a condition that the temperature of the first battery 211 or the second battery 213 is higher than the threshold temperature, a condition that the difference of SOC(state of charge) between the first battery 211 and the second battery 213 exceeds the threshold SOC value, or a condition that each of either the first battery 211 or the second battery 213 has broken down, so that the battery is unusable or the output of the battery is limited.

The sensor unit 250 measures the voltage and temperature of the batteries 210. The vehicle control unit 270 is configured to control the vehicle based on the power output from the first battery and the second battery 211, 213.

According to an exemplary embodiment of the present disclosure, each of the first battery management unit 231 and the second battery management unit 233 may be implemented by a processor (e.g., computer, microprocessor, CPU, ASIC, circuitry, logic circuits, etc.). Each of the first battery management unit 231 and the second battery management unit 233 may be implemented by a non-transitory memory storing, e.g., a program(s), software instructions reproducing algorithms, etc., which, when executed, controls operations of various components of the vehicle, and a processor configured to execute the program(s), software instructions reproducing algorithms, etc. Alternatively, the first battery management unit 231 and the second battery management unit 233 may be integrated in a single processor.

According to an exemplary embodiment of the present disclosure, each of the first battery management unit 231, the second battery management unit 233, and the vehicle control unit 270 may be implemented by a processor (e.g., computer, microprocessor, CPU, ASIC, circuitry, logic circuits, etc.). Each of the first battery management unit 231, the second battery management unit 233 and vehicle control unit 270 may be implemented by a non-transitory memory storing, e.g., a program(s), software instructions reproducing algorithms, etc., which, when executed, controls operations of various components of the vehicle, and a processor configured to execute the program(s), software instructions reproducing algorithms, etc. Alternatively, the first battery management unit 231, the second battery management unit 233 and the vehicle control unit 270 may be integrated in a single processor.

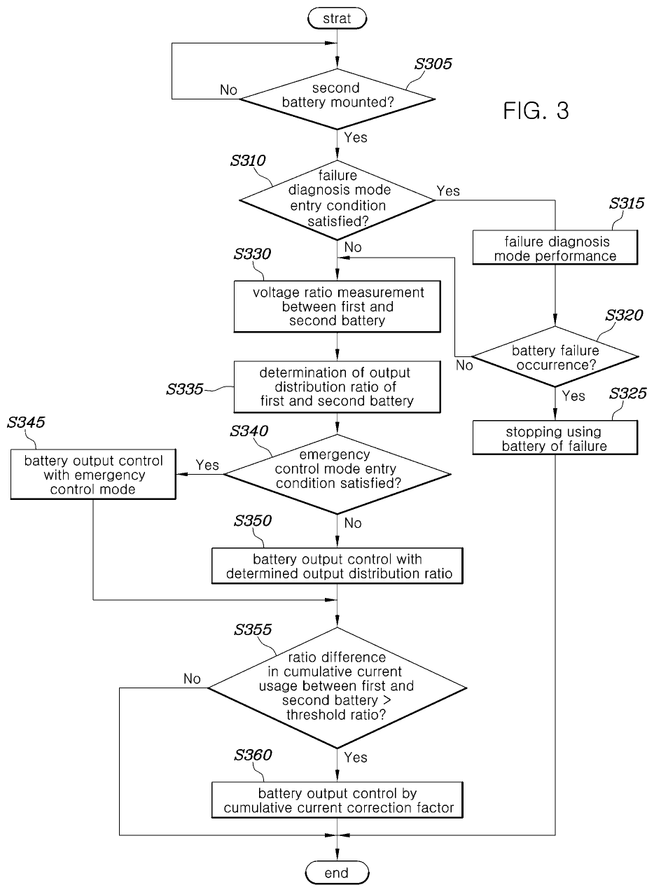

FIG. 3 is a flowchart schematically showing the apparatus for controlling the battery of the eco-friendly according to an exemplary embodiment of the present disclosure.

The battery control method according to the exemplary embodiment may be performed by the battery management unit 230 of FIG. 2.

Referring to FIG. 3, the battery management unit 230 is configured to determine whether the second battery is mounted (S305) on the vehicle and whether the battery 210 satisfies the failure diagnosis mode entry condition when the second battery is mounted, and performs (S315) the failure diagnosis mode when the failure diagnosis mode entry condition is satisfied.

For example, the failure diagnosis mode entry condition may be combined based on three conditions below.
(Condition 1) When the cumulative current correction factor (Com_Factor) is a first threshold value.
(Condition 2) When the absolute value of the difference between the cumulative usage of the first battery 211 and the cumulative usage of the second battery 213 is greater than or equal to a second threshold value.
(Condition 3) When a deviation of SOHs (State of Health) between the first battery 211 and the second battery 213 is greater than or equal to a third threshold value.

For example, the battery management unit 230 may be set to enter the battery failure diagnosis mode for checking the first battery and the second battery 211, 213 when the condition 1 and the condition 2 are satisfied, or when the condition 3 is satisfied.

Meanwhile, the battery management unit 230 is configured to determine (S320) whether the batteries 210 break down as a result of performing the failure diagnosis mode. Therefore, when the batteries 210 have broken down, the battery management unit 230 stops (S325) using the batteries having broken down.

As a result of a determination of S310, when the batteries 210 do not satisfy the failure diagnosis mode entry condition, the battery management unit 230 measures (S330) the voltage ratio between the first battery and the second battery 211, 213, and is configured to determine (S335) the output distribution ratio of the first battery and the second battery based on the voltage ratio between the first battery and the second battery 211, 213.

For example, the output of the first battery and the second battery 211, 213 may be determined based on the Equation 1 and the Equation 2.

Additionally, the battery management unit 230 is configured to determine whether the batteries 210 satisfy (S340) the emergency control mode entry condition, and when the emergency control mode entry condition is satisfied, the battery management unit 230 is configured to control (S345) the battery output in the emergency control mode.

For example, the emergency control mode entry condition may be determined to be satisfied in either a condition that the temperature of the first battery 211 or the second battery 213 is higher than the threshold temperature, a condition that the difference of SOC s(state of charge) between the first battery 211 and the second battery 213 exceeds the threshold SOC value, or a condition that one of the first battery 211 or the second battery 213 fails, or an output of the one battery is limited.

For example, when an output equal to or greater than the threshold output is required within a short period of the threshold time, such as a time that the vehicle suddenly accelerates or climbs a hill, the battery management unit 230 may be configured for controlling the first battery 211 to take charge of all the required output of the vehicle.

Meanwhile, when the temperature of the first battery 211 is higher than the threshold temperature, the battery management unit 230 may adjust the output distribution ratio so that the output ratio of the second battery 213 may be higher than the voltage ratio between the first battery and the second battery.

Conversely, when the temperature of the second battery 213 is higher than the threshold temperature, the battery management unit 230 may adjust the output distribution ratio so that the output ratio of the first battery 211 may be higher than the voltage ratio between the first battery and the second battery.

Furthermore, when the difference of State of Charge (SOC) between the first battery 211 and the second battery 213 exceeds the threshold SOC value, the output distribution ratio may be adjusted so that the output ratio of a battery having a higher SOC between the first battery 211 and the second battery 213 may be higher than the voltage ratio between the first battery and the second battery.

Furthermore, when one of either the first battery 211 or the second battery 213 has broken down and the battery is unusable or the output of the battery is limited, the output distribution ratio may be adjusted so that the output ratio of the other battery not having broken down may be higher than the voltage ratio between the first battery and the second battery.

As a result of a determination of S340, when the emergency control mode entry condition is not satisfied, the battery management unit 230 is configured to control (S350) the output of the batteries 210 based on the output distribution ratio of a determination of S335.

Additionally, the battery management unit 230 is configured to determine whether the difference (S355) in the ratio of the cumulative current usage between the first battery and the second battery 211, 213 is greater than the threshold ratio. Therefore, when the difference in the cumulative current usage between the first battery and the second battery 211, 213 is greater than the threshold ratio, the battery management unit 230 is configured to control (S360) the battery output by reflecting the cumulative current correction factor and supplies the power to the vehicle.

For example, the difference in the ratio of the cumulative current usage indicates the difference between the ratio of the cumulative current usage to the total available current of the first battery 211 and the ratio of the cumulative current usage to the total available current of the second battery 213.

For example, the output of each of the first battery 211 and the second battery 213 may be determined using the Equation 3 and 4, and the cumulative current correction factor may be determined using the Equation 5.

According to the exemplary embodiments of the present disclosure described so far, a rapid deterioration of the auxiliary battery may be prevented through a deterioration balancing control between the main battery and the auxiliary battery.

Additionally, performance of the batteries may be maximized through balanced use of batteries.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for controlling a battery of a vehicle, the method comprising:
determining an output distribution ratio for a required output of the vehicle based on a voltage of each of a first battery and a second battery;
supplying a power to the vehicle by controlling an output of the first battery and the second battery based on the output distribution ratio; and
in response that a preset emergency control mode entry condition is satisfied, adjusting the output distribution ratio based on the satisfied emergency control entry condition.

2. The method of claim 1, wherein the output distribution ratio is determined to be a same as a ratio of the voltages of the first battery and the second battery.

3. The method of claim 1, further including:
comparing a difference in a ratio of a cumulative current usage between the first battery and the second battery with a preset threshold ratio; and
controlling the output of the first battery and the second battery based on a cumulative current correction factor in response that the difference in the ratio of the cumulative current usage between the first battery and the second battery is greater than the preset threshold ratio.

4. The method of claim 3, wherein the cumulative current correction factor is determined based on the equation below,
$$Com\_Factor = 1 - \frac{S\_Acc \_Current}{M\_Acc \_Current}$$
where Com_Factor is the cumulative current correction factor, M_Acc_Current is the cumulative current usage of the first battery, and S_Acc_Current is the cumulative current usage of the second battery.

5. The method of claim 1, wherein the satisfied emergency control mode entry condition includes a condition that a temperature of the first battery or the second battery is higher than a threshold temperature, a condition that a difference value between state of charge (SOC) value of the first battery and SOC value of the second battery exceeds a threshold SOC value, or a condition that one of the first battery and the second battery fails or an output of the one battery is limited.

6. The method of claim 1, further including:
controlling the output of the first battery and the second battery and supplying a power to the vehicle based on a cumulative current usage of the first battery and the second battery in response that a difference in the cumulative current usage between the first battery and the second battery is greater than a threshold ratio.

7. The method of claim 1, wherein the adjusting the output distribution ratio includes supplying the power to the vehicle only from the output of the first battery or the second battery, in response that the vehicle requires an output equal to or greater than a threshold output within a threshold time.

8. The method of claim 1, wherein the adjusting the output distribution ratio includes adjusting the output distribution ratio so that an output ratio of a battery having a higher SOC value among the first battery and the second battery is higher than a voltage ratio of the first battery and the second battery, in response that a difference value between state of charge (SOC) value of the first battery and SOC value of the second battery exceeds a threshold SOC value.

9. The method of claim 1, wherein the adjusting the output distribution ratio includes, in response that one of the first battery or the second battery fails or an output of the one battery is limited, adjusting the output distribution ratio so that an output ratio of the other battery of the first battery or the second battery is higher than a voltage ratio of the first battery and the second battery.

10. The method of claim 1, further including:
recognizing the second battery by a controller controlling the first battery.

11. An apparatus for controlling a battery of a vehicle, the apparatus comprising:
a first battery and a second battery configured to store a power energy for driving the vehicle;
a sensor unit including a voltage sensor configured to detect a voltage of each of the first battery and the second battery; and
a battery management unit operatively connected to the sensor unit and configured to determine an output distribution ratio for a required output of the vehicle based on the voltage of each of the first battery and the second battery, control an output of the first battery and the second battery based on the output distribution ratio so that a power is supplied to the vehicle, and in response that a preset emergency control entry condition is satisfied, adjust the output distribution ratio based on the satisfied emergency control entry condition.

12. The apparatus of claim 11, wherein the output distribution ratio is determined by the battery management unit to be a same as a voltage ratio of the first battery and the second battery.

13. The apparatus of claim 11, wherein the battery management unit is further configured to compare a difference in a ratio of a cumulative current usage between the first battery and the second battery with a preset threshold ratio, and control the output of the first battery and the second battery based on a cumulative current correction factor, in response that the difference in the ratio of the cumulative current usage is greater than the preset threshold ratio.

14. The apparatus of claim 13, wherein the cumulative current correction factor is determined based on the equation below,
$$Com\_Factor = 1 - \frac{S\_Acc \_Current}{M\_Acc \_Current}$$
where Com_Factor is the cumulative current correction factor, M_Acc_Current is the cumulative current usage of the first battery, and S_Acc_Current is the cumulative current usage of the second battery.

15. The apparatus of claim 11, wherein the satisfied emergency control mode entry condition is satisfied under a condition that a temperature of the first battery or the second battery is higher than a threshold temperature, a condition that a difference between SOC value of the first battery and SOC value of the second battery exceeds a threshold SOC value, or a condition that one of the first battery and the second battery fails or the output of the one battery is limited.

16. The apparatus of claim 11, wherein the battery management unit is further configured to control the output of the first battery and the second battery so that the power is supplied to the vehicle based on a cumulative current usage of the first battery and the second battery, in response that a difference in the cumulative current usage between the first battery and the second battery is greater than a threshold ratio.

17. The apparatus of claim 16, wherein in response that the vehicle requires an output equal to or greater than a threshold output within a threshold time, the battery management unit is further configured to control the power to be supplied to the vehicle only from the output of either one of the first battery or the second battery.

18. The apparatus of claim 16, wherein in response that a difference value between state of charge (SOC) value of the first battery and SOC value of the second battery exceeds a threshold SOC value, the battery management unit is further configured to adjust the output distribution ratio so that an output ratio of a battery having a higher SOC value among the first battery or the second battery is higher than a voltage ratio of the first battery or the second battery.

19. The apparatus of claim 16, wherein in response that one of the first battery and the second battery fails or an output of the one battery is limited, the battery management unit is further configured to adjust the output distribution ratio so that an output ratio of the other battery of the first battery or the second battery is higher than a voltage ratio of the first battery and the second battery.

20. The apparatus of claim 11,
wherein the first battery includes the controller recognizing the second battery.
